(19) United States
(12) Patent Application Publication
(10) Pub. No.: US 2024/0339692 A1
(43) Pub. Date: Oct. 10, 2024

(54) BATTERY WITH THERMALLY COUPLED BUSSING

(71) Applicant: Apple Inc., Cupertino, CA (US)

(72) Inventors: Dylan C Erb, San Jose, CA (US); John M Schoech, San Jose, CA (US); Nivay Anandarajah, San Leandro, CA (US); Alexander Bartlett, San Jose, CA (US); Abraham B Caulk, Livermore, CA (US); Joseph D Rainey, Sunnyvale, CA (US); Berton Vite, Santa Ana, CA (US)

(21) Appl. No.: 18/600,279

(22) Filed: Mar. 8, 2024

Related U.S. Application Data
(60) Provisional application No. 63/458,271, filed on Apr. 10, 2023.

(51) Int. Cl. H01M 10/653; H01M 10/46; H01M 50/209; H01M 50/271; H01M 50/507; H02J 7/00

(52) U.S. Cl. CPC H01M 10/653; H01M 10/46; H01M 50/209; H01M 50/271; H01M 50/507; H02J 7/0013; H02J 7/0042; H02J 7/00712

(57) ABSTRACT

A battery pack includes a first busbar, a second busbar, and a thermal interface material (TIM) including a thermal conductivity constant (k) value between 1.0 and 7.0 watts per meter-kelvin (W/mK). The TIM establishes a thermal interface between the first busbar and the second busbar. The battery pack also includes a control assembly configured to regulate a charging mode of the battery pack in which the first busbar is active and receives an electrical current and the second busbar is inactive.

### CROSS-REFERENCE

This application claims priority to U.S. Application No. 63/458,271, filed Apr. 10, 2023, entitled “BATTERY WITH THERMALLY COUPLED BUSSING,” which is incorporated by reference herein in its entirety for all purposes.

### BACKGROUND

The present disclosure relates generally to a battery pack. More specifically, the present disclosure relates to thermally coupled bussing of the battery pack.

A battery pack may include a number of battery cells, such as lithium-ion cells, configured to generate a charge having a voltage and current for powering a load. For example, the battery cells may be coupled in series such that individual voltages of the battery cells are combined to generate a charge having a total voltage, or in parallel such that individual currents of the battery cells are combined to generate a charge having a total current. In some embodiments, series and parallel couplings are employed between various battery cells of the battery pack to generate a total voltage and total current compatible with the load receiving the charge.

Battery pack bussing, such as busbars, may be employed to couple the battery pack with one or more loads, one or more chargers, and/or other external componentry. Generally, the busbars are sized according to the highest temperature and root mean square (RMS) current that each busbar will be subjected to across all use cases. That is, the maximum temperature achieved across all use cases may dictate a necessary size of the busbar to maintain stable, safe, efficient, and/or effective operation of the battery pack. In traditional configurations, such busbars may be relatively large due to relative high temperatures experienced by the busbars, thereby reducing an energy density of the battery pack. Accordingly, it is now recognized that improved battery packs and battery pack bussing are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery pack includes a first busbar, a second busbar, and a thermal interface material (TIM) including a thermal conductivity constant (k) value between 1.0 and 7.0 watts per meter-kelvin (W/mK). The TIM establishes a thermal interface between the first busbar and the second busbar. The battery pack also includes a control assembly configured to regulate a charging mode of the battery pack in which the first busbar is active and receives an electrical current and the second busbar is inactive.

In another embodiment, a battery pack includes an enclosure, battery cells disposed in the enclosure, and a fast charging or stack busbar disposed in the enclosure, electrically coupled with the battery cells, and configured to establish a first electrical connection between a charger and the battery cells. The battery pack also includes a drivetrain busbar disposed in the enclosure, electrically coupled with the battery cells, and configured to establish a second electrical connection between the battery cells and one or more loads. The battery pack also includes a thermal interface material (TIM) establishing a thermal interface between the fast charging or stack busbar and the drivetrain busbar.

In yet another embodiment, bussing assembly configured to be disposed in an enclosure of a battery pack includes a first busbar configured to be active in a charging mode of the battery pack, a second busbar configured to be inactive in the charging mode of the battery pack, and a thermal interface material (TIM). The TIM includes a thermal conductivity constant (k) value between 1.0 and 7.0 watts per meter-kelvin (W/mK). Further, the TIM establishes a thermal interface between the first busbar and the second busbar.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic diagram of a battery pack including a bussing assembly with a first busbar, a second busbar, and a thermal interface material (TIM), according to embodiments of the present disclosure;

FIG. 2 is an exploded perspective view of the battery pack of FIG. 1, according to embodiments of the present disclosure;

FIG. 3 is a perspective view of a portion of the battery pack of FIG. 1, including fast charging or stack busbars and drivetrain busbars, according to embodiments of the present disclosure;

FIG. 4 is an overhead view of a portion of the battery pack of FIG. 1, where the TIM is disposed at a hot spot of the battery pack, according to embodiments of the present disclosure;

FIG. 5 is an overhead view of a portion of the battery pack of FIG. 1, where the TIM extends along a majority of a longitudinal portion of the bussing assembly, according to embodiments of the present disclosure;

FIG. 6 is a cross-sectional side view of the battery pack of FIG. 1, including example locations of various portions of the TIM, according to embodiments of the present disclosure; and

FIG. 7 is an electrical routing diagram of the battery pack of FIG. 1, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure relates generally to thermally coupled bussing of a battery pack. More particularly, the present disclosure relates to a thermal interface material (TIM) establishing a thermal interface between a first busbar and a second busbar, where the first busbar is active during different time periods or battery pack modes than the second busbar. As an example, the first busbar is active (e.g., receiving a current) during a charging mode (e.g., fast charging mode) of the battery pack and the second busbar is inactive (e.g., not receiving a current) during the charging mode of the battery pack. In this way, a portion of heat generated in the first busbar during the charging mode is transferred to the second busbar. By employing these and other features, sizes of the first busbar and/or the second busbar may be reduced relative to traditional configurations, thereby increasing an energy density of the battery pack.

A battery pack includes battery cells electrically coupled to form an interconnected group of battery cells configured to power one or more loads. In some embodiments, the battery pack may include multiple interconnected groups of battery cells (e.g., a high voltage group and a low voltage group). Battery pack bussing, such as busbars, may be employed to couple the interconnected group(s) of battery cells of the battery pack with one or more loads, one or more chargers, and/or other external componentry. Generally, the busbars are sized according to the highest temperature and root mean square (RMS) current that each busbar will be subjected to across all use cases. That is, the maximum temperature achieved across all use cases may dictate a necessary size of the busbar to maintain stable, safe, efficient, and/or effective operation of the battery pack.

In accordance with embodiments of the present disclosure, a thermal interface material (TIM), such as a material including a thermal conductivity constant (k) value between 1.0 and 7.0 watts per meter-kelvin (W/mK), may establish a thermal interface between a first busbar and a second busbar of a bussing assembly of the battery pack. The first busbar may be, for example, a fast charging or stack busbar employed to charge the battery cells of the battery pack. The second busbar may be, for example, a drivetrain busbar configured to couple the battery pack with one or more loads powered by the battery pack. In a charging mode (e.g., fast charging mode) of the battery pack, the fast charging or stack busbar is active (e.g., receive a current) and the drivetrain busbar is inactive (e.g., not receive a current). Thus, a portion of heat generated in the fast charging or stack busbar is transferred to the drivetrain busbar during the charging mode of the battery pack. Additionally or alternatively, in a discharging mode of the battery pack, during which the battery pack powers one or more loads, the drivetrain busbar is active (e.g., receive a current) and the fast charging or stack busbar is inactive (e.g., not receive a current). Thus, a portion of heat generated in the drivetrain busbar is transferred to the fast charging or stack busbar during the discharging mode of the battery pack.

The above-described example employing the fast charging or stack busbar and the drivetrain busbar is non-limiting. Indeed, the TIM may be employed between other busbars in accordance with the present disclosure, such as a high voltage busbar corresponding to a high voltage portion of the battery pack and a low voltage busbar corresponding to a low voltage portion of the battery pack. In general, the TIM is employed between two busbars that are active at different periods of time and/or during different modes (e.g., operating modes, such as fast charging mode and discharging mode) of the battery pack. In this way, heat generated in one busbar is transferred to another busbar in which heat is not being generated. By employing these and other features of the present disclosure, busbar sizing (e.g., length and/or cross-sectional width) is reduced and battery pack energy density is increased over traditional configurations. These and other features of the present disclosure are described in detail below with reference to the drawings.

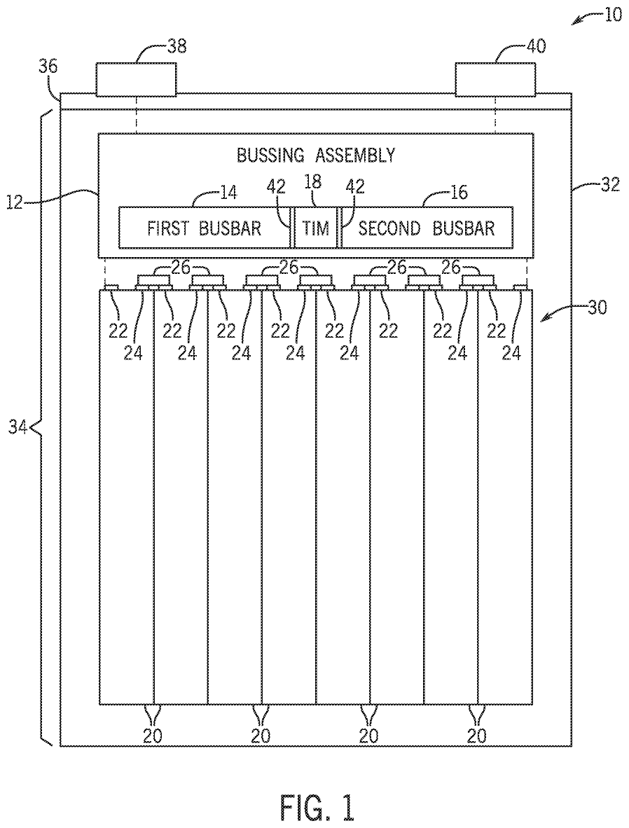

FIG. 1 is a schematic diagram of an embodiment of a battery pack 10 including a bussing assembly 12 with a first busbar 14, a second busbar 16, and a thermal interface material (TIM) 18 establishing a thermal interface between the first busbar 14 and the second busbar 16. The battery pack 10 also includes a number of battery cells 20 electrically connected (e.g., via battery cell terminals 22, 24 and bus bars 26 coupling the battery cell terminals 22, 24, as shown) to form a group 28 of electrically interconnected battery cells 30.

In FIG. 1, the bussing assembly 12 and the group 30 of electrically interconnected battery cells 20 are disposed in an enclosure 32. For example, the enclosure 32 includes a base 34 configured to receive the bussing assembly 12 and the group 30 of electrically interconnected battery cells 20, among other features. The enclosure 32 also includes a lid 36 configured to be coupled to the base 34 to enclose the group 30 of electrically interconnected battery cells 20 and at least a portion of the bussing assembly 12 within the enclosure 32. Connectors 38, 40 (e.g., battery pack terminals) protrude from the lid 36 in the illustrated embodiment, and are configured to couple the battery pack 10 to one or more loads to enable powering of the one or more loads via the battery pack 10, to one or more chargers to enable charging of the group 30 of electrically interconnected battery cells 20, or both. While the connectors 38, 40 protrude from the lid 36 in the illustrated embodiment, the connectors 38, 40 may protrude from a wall of the base 34 in other embodiments. Further, in some embodiments, the battery pack 10 includes more than one group 30 of electrically interconnected battery cells 20, such as a high voltage group used for high voltage loads and a low voltage group used for low voltage loads. In general, the bussing assembly 12 is employed to establish an electrical coupling between the one or more groups 30 of electrically interconnected battery cells 20 and the connectors 38, 40. While only two connectors 38, 40 are shown in FIG. 1, more than two connectors 38, 40 are employed in other embodiments.

In general, the TIM 18 is configured to established a thermal interface between two busbars, such as the first busbar 14 and the second busbar 16, that are active at different time periods and/or during different modes (e.g., operating modes) of the battery pack 10. As an example, in one embodiment, the first busbar 14 is a fast charging or stack busbar configured to receive a current during a charging mode (e.g., fast charging mode) of the battery pack 10, and the second busbar 16 is a drivetrain busbar configured to receive a current during a discharging mode of the battery pack 10 (e.g., while the battery pack 10 powers one or more loads). During the charging mode, the TIM 18 transfers heat from the first busbar 14 corresponding to the fast charging or stack busbar, which is active and generating heat, to the second busbar 16 corresponding to the drivetrain busbar, which is inactive and not generating heat. Thus, the heat generated by the first busbar 14 is shared between the first busbar 14 and the second busbar 16. Similarly, during the discharging mode, the TIM 18 transfers heat from the second busbar 16 corresponding to the drivetrain busbar, which is active and generating heat, to the first busbar 14 corresponding to the fast charging or stack busbar, which is inactive and not generating heat. Thus, the heat generated by the second busbar 16 is shared between the second busbar 16 and the first busbar 14.

In this way, the maximum temperature experienced by the first busbar 14 and/or the second busbar 16 is reduced relative to traditional configurations not employing the TIM 18. By reducing the maximum temperature experienced by the first busbar 14 and/or the second busbar 16, sizes (e.g., lengths and/or cross-sectional widths) of the first busbar 14 and/or the second busbar 16 are reduced relative to traditional configurations, thereby improving the energy density of the battery pack 10 and reducing a cost of the first busbar 14 and/or the second busbar 16 (and, thus, a cost of the battery pack 10). It should be noted that the above-described example, in which the first busbar 14 corresponds to the fast charging or stack busbar and the second busbar 16 corresponds to the drivetrain busbar, is non-limiting and other examples in accordance with the present disclosure are also possible. For example, the first busbar 14 may correspond to a high voltage busbar that is active during one or more operating modes of the battery pack 10 and the second busbar 16 may correspond to a low voltage busbar that is inactive during the one or more operating modes of the battery pack 10.

In accordance with the present disclosure, the TIM 18 includes a material with a relatively high thermal conductivity constant (k) value adequate for the above-described heat transfer, such as a k value between 1.0 and 7.0 watts per meter-kelvin (W/mK). In some embodiments, the TIM 18 includes a k value between 2.5 and 6.0 W/mK. The TIM 18 may include, for example, a liquid material that is cured between the first busbar 14 and the second busbar 16. Additionally or alternatively, the TIM 18 may include a pad that is coupled or bonded to the first busbar 14 and/or the second busbar 16 with (or without) one or more pressure sensitive adhesives (PSA) layers 42. In some embodiments, the TIM 18 directly contacts the first busbar 14, the second busbar 16, or both. As described in detail with reference to later drawings, the TIM 18 may also be employed between at least one of the first busbar 14 or the second busbar 16 and another aspect of the battery pack 10, such as the lid 36.

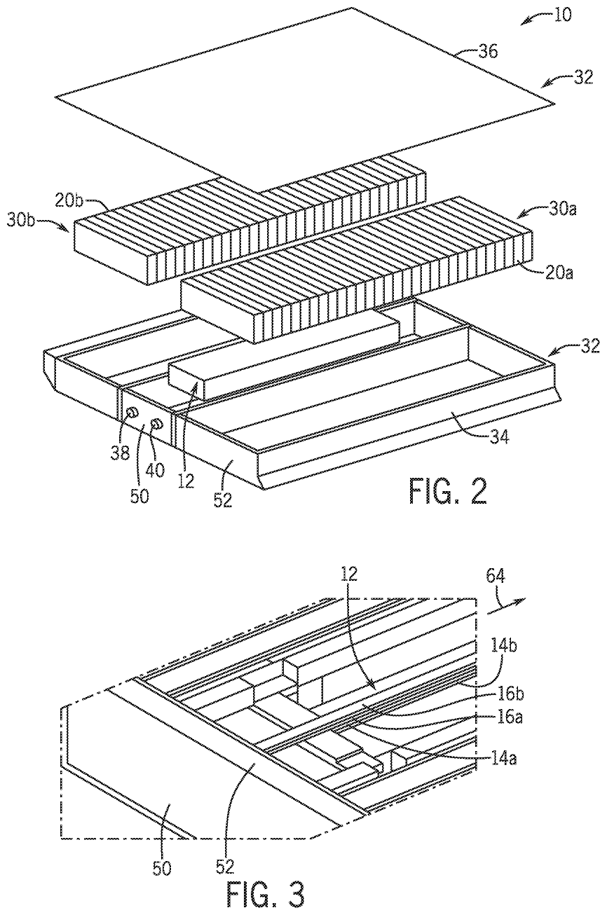

FIG. 2 is an exploded perspective view of an embodiment of the battery pack 10 of FIG. 1. In the illustrated embodiment, the battery pack 10 includes a first group 30a of electrically interconnected battery cells 20a (e.g., high voltage group) and a second group 30b of electrically interconnected battery cells 20b (e.g., low voltage group). The battery pack 10 also includes the bussing assembly 12 which, as previously described, includes a number of busbars employed to couple the battery pack 10 to a load, to a charger, etc. In the illustrated embodiment, a connector panel 50 is disposed in a wall 52 of the base 34 of the battery pack 10. While the first connector 38 (e.g., first battery pack terminal) and the second connector 40 (e.g., second battery pack terminal) protrude from the connector panel 50 in the illustrated embodiment, additional connectors may be employed in other embodiments. Further, additional connector panels may be employed in other embodiments, such as additional connector panels disposed in locations other than the wall 52 of the base 34 of the enclosure 32.

In general, the bussing assembly 12 includes various busbars electrically coupling the first group 30a of electrically interconnected battery cells 20a and/or the second group 30b of electrically interconnected battery cells 20b to various ones of the connectors (e.g., the first connector 38, the second connector 40, and/or other connectors). As described in detail below with reference to other drawings, and above with reference to FIG. 1, the bussing assembly 12 includes multiple busbars that are active during different time periods and/or different modes (e.g., operating modes, such as a fast charging mode and a discharging mode) of the battery pack 10. The TIM 18 illustrated in FIG. 1 and described in detail above and below is employed to establish a thermal interface between two such busbars (e.g., a first busbar active and receiving a current in a first mode, and a second busbar inactive and not receiving a current in the first mode). Thus, heat is shared between various ones of the busbars of the bussing assembly 12, thereby reducing a maximum temperature each busbar experiences and a necessary size of each busbar, which is dependent at least in part on the maximum temperature experienced by each busbar of the battery pack 10.

For example, FIG. 3 is a perspective view of a portion of the battery pack of FIG. 1, including fast charging or stack busbars 14a, 14b (e.g., corresponding to the first busbar 14 described above with respect to FIG. 1) and drivetrain busbars 16a, 16b (e.g., corresponding to the second busbar 16 described above with respect to FIG. 1). A first fast charging or stack busbar 14a is employed for the first group 30a of electrically interconnected battery cells 20a illustrated in FIG. 2, and a second fast charging or stack busbar 14b is employed for the second group 30b of electrically interconnected battery cells 20b illustrated in FIG. 2. Likewise, a first drivetrain busbar 16a is employed for the first group 30a of electrically interconnected battery cells 20a illustrated in FIG. 2, and a second drivetrain busbar 16b is employed for the second group 30b of electrically interconnected battery cells 20b illustrated in FIG. 2. Other busbars and/or busbar arrangements are also possible. The fast charging or stack busbars 14a, 14b and the drivetrain busbars 16a, 16b are coupled to connectors (not shown in the illustrated embodiment) corresponding to the connector panel 50 in the enclosure wall 52 of the battery pack 10.

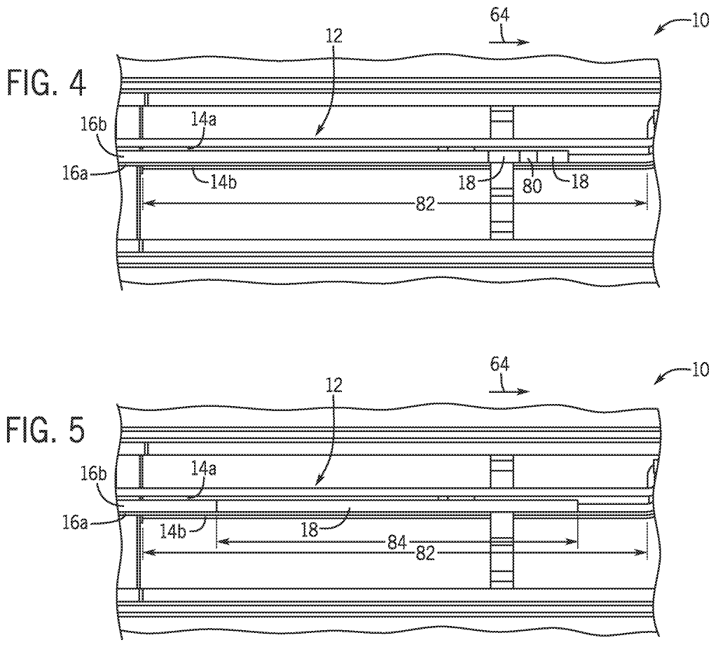

As shown, the various busbars 14a, 14b, 16a, 16b of the bussing assembly 12 may be arranged in close proximity in at least a portion of the battery pack 10. In some embodiments, a clip is employed to receive the various busbars 14a, 14b, 16a, 16b of the bussing assembly 12 at a portion of the battery pack 10 in which the various busbars 14a, 14b, 16a, 16b extend in a common direction 64. In this way, the TIM (not shown) may establish the thermal interface between certain ones of the busbars 14a, 14b, 16a, 16b, as outlined in detail below with reference to FIGS. 4 and 5.

FIG. 4 is an overhead view of a portion of an embodiment of the battery pack 10 of FIG. 1, where the TIM 18 is disposed at (or adjacent to) a hot spot 80 of the battery pack 10. FIG. 5 is an overhead view of a portion of an embodiment of the battery pack 10 of FIG. 1, where the TIM 18 extends along a majority of a longitudinal portion 82 of the bussing assembly 12. As previously described, one or more clips may be employed to receive and/or retain the various busbars 14a, 14b, 16a, 16b of the bussing assembly 12 at location(s) in which the various busbars 14a, 14b, 16a, 16b extend in the common direction 64. In this way, the various busbars 14a, 14b, 16a, 16b are disposed in close proximity to one another, thereby enabling the TIM 18 to establish at least one thermal interface between certain ones of the various busbars 14a, 14b, 16a, 16b. This area (or these areas) may be referred to as a longitudinal portion 82 of the bussing assembly 12.

Focusing first on FIG. 4, the TIM 18 is disposed on either side of the hot spot 80 of the battery pack 10. The hot spot 80 of the battery pack 10 may include an area of the battery pack 10 expected to reach higher temperatures than other areas of the battery pack 10. The hot spot 80 may correspond to, for example, a location in which a shunt of the battery pack 10 is disposed (e.g., where the shunt is employed to measure current). Other locations of the hot spot(s) 80 are also possible. In FIG. 4, the TIM 18 is disposed on either side of the illustrated hot spot 80 (e.g., a first portion of the TIM 18 on one side of the hot spot 80 and a second portion of the TIM 18 on another side of the hot spot 80, or a single portion extending over the hot spot 80 to opposing sides of the hot spot 80). Further, in FIG. 4, the TIM 18 is not disposed in certain other locations of the longitudinal portion 82 in the bussing assembly 12 that do not correspond to the hot spot 80.

Focusing now on FIG. 5, a thermal interface 84 defined by the TIM 18 extends along a majority of the longitudinal portion 82 of the bussing assembly 12. While material cost in FIG. 5 may be greater than material cost in FIG. 4 (e.g., due to a larger amount of the TIM 18), heat transfer in FIG. 5 may be greater than heat transfer in FIG. 4. The TIM 18 in FIGS. 4 and 5 may be configured to transfer heat between the first fast charging or stack busbar 14a and the first drivetrain busbar 16a, the first fast charging or stack busbar 14a and the second drivetrain busbar 16b, the second fast charging or stack busbar 14b and the first drivetrain busbar 16a, the second fast charging or stack busbar 14b and the second drivetrain busbar 16b, or any combination thereof.

Use of the TIM 18 between other busbars of the battery pack 10 are also possible in accordance with the present disclosure. In general, the TIM 18 establishes a thermal interface between at least one pair of busbars in which a first busbar of the pair is active and receives a current in an operating mode and the second busbar of the pair is inactive and does not receive a current in the operating mode. In this way, heat is transferred from the active, heat-generating busbar to the inactive busbar. That is, heat is shared between the busbars of the pair, thereby reducing a maximum temperature experienced by the pair of busbars in one or more (e.g., all) use cases. Because of the reduction in the maximum temperature experienced by the busbars, sizes (e.g., cross-sectional widths) of the busbars may be reduced, thereby improving an energy density of the battery pack 10.

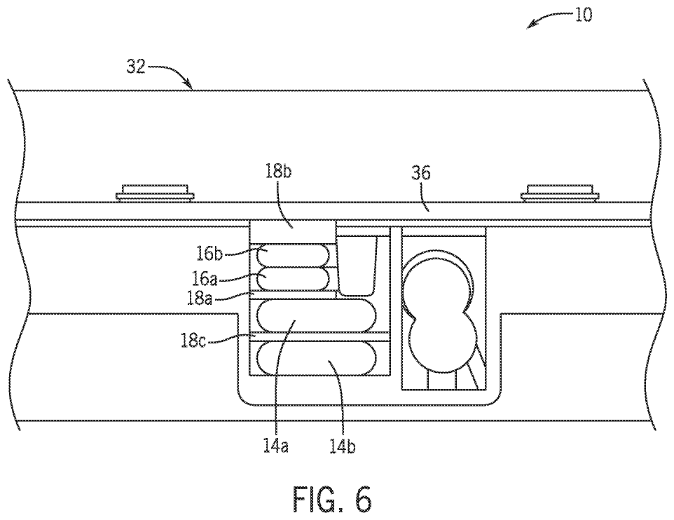

FIG. 6 is a cross-sectional side view of an embodiment of the battery pack 10 of FIG. 1, including example locations of various portions of the TIM 18. For example, a first TIM portion 18a is disposed between the first fast charging or stack busbar 14a and the first drivetrain busbar 16a, a second TIM portion 18b is disposed between the second drivetrain busbar 16b and the lid 36 of the enclosure 32 of the battery pack 10, and a third TIM portion 18c is disposed between the first fast charging or stack busbar 14a and the second fast charging or stack busbar 14b.

In general, as previously described, the various TIM portions 18a, 18b, 18c are configured to establish corresponding thermal interfaces between the adjacent componentry. That is, the first TIM portion 18a establishes a first thermal interface between the first fast charging or stack busbar 14a and the first drivetrain busbar 16a, the second TIM portion 18b establishes a second thermal interface between the second drivetrain busbar 16b and the lid 36, and the third TIM portion 18c establishes a third thermal interface between the first fast charging or stack busbar 14a and the second fast charging or stack busbar 14b. While the TIM portions 18a, 18b, 18c may include the same material composition, in another embodiment, material composition between the TIM portions 18a, 18b, 18c may differ. In general, the TIM portions 18a, 18b, 18c each include a k value between 1.0 and 7.0 W/mK, or between 2.5 and 6.0 W/mK.

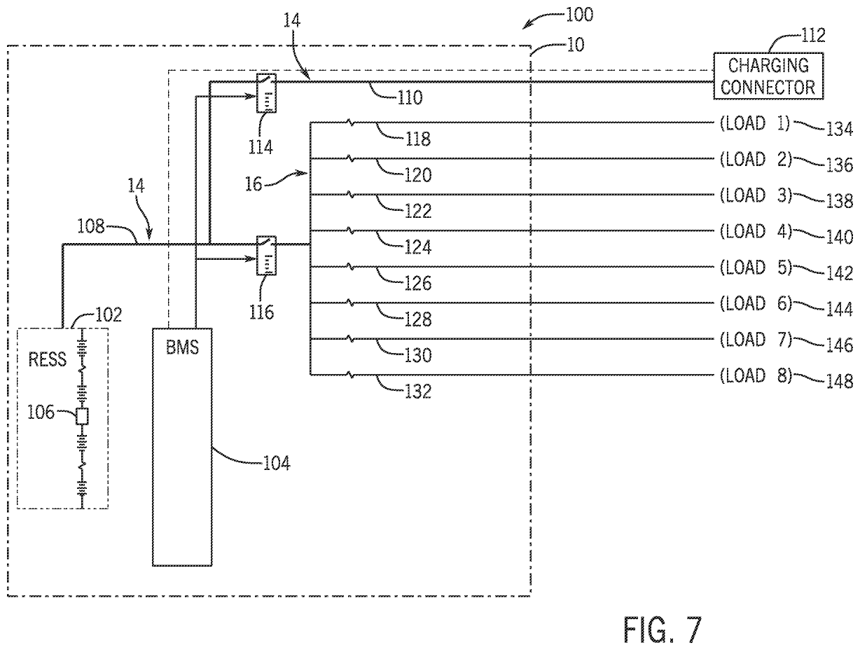

FIG. 7 is an electrical routing diagram 100 corresponding to an embodiment of the battery pack 10 of FIG. 1. It should be understood that the spatial arrangement of various componentry of the electrical routing diagram 100 is not indicative of the actual spatial arrangement of said componentry in the battery pack 10. That is, while the electrical routing diagram 100 illustrates actual connections between various componentry of the battery pack 10, the spatial arrangement of said componentry in the electrical routing diagram 100 of FIG. 7 is not indicative of the spatial arrangement that would be employed in the battery pack 10.

In the illustrated embodiment, the battery pack 10 includes a rechargeable energy storage system (RESS) 102, such as a high voltage (HV) RESS, and a battery management system (BMS) 104 (e.g., a control assembly or part of a control assembly). The RESS 102 includes, for example, battery cells and other componentry, such as a shunt 106 employed to measure current associated with the battery pack 10. The fast charging or stack busbar 14 includes a stack portion 108 and a fast charging portion 110, as shown, where the fast charging portion 110 is configured to be coupled to a charging connector 112. The stack portion 108 is coupled to the fast charging portion 110 and the RESS 102, such that the stack portion 108 and the fast charging portion 110 establish an electrical connection between the charging connector 112 and the RESS 102. A first contactor 114 is disposed in the fast charging portion 110. The BMS 104 is configured to control the first contactor 114 to couple and decouple the stack portion 108 and the fast charging portion 110, depending on the mode of the battery pack 10. For example, in a charging mode (e.g., fast charging mode), the BMS 104 closes the first contactor 114 such that the battery cells in the RESS 102 can be charged. During a discharging mode, the BMS 104 opens the first contactor 114 to break the electrical connection between the charging connector 112 and the RESS 102.

The stack portion 108 is also employed to couple the drivetrain busbar 16 with the RESS 102. The drivetrain busbar 16 includes several prongs 118, 120, 122, 124, 126, 128, 130, 132 corresponding to respective loads 134, 136, 138, 140, 142, 144, 146, 148. Although not shown in the illustrated embodiment, in certain other embodiments, the drivetrain busbar 16 also includes a prong connected to the charging connector 112, which may be employed for charging modes other than the charging mode (e.g., fast charging mode) corresponding to the fast charging or stack busbar 14. A second contactor 116 is controlled by the BMS 104 to establish or break an electrical connection between the various prongs 118, 120, 122, 124, 126, 128, 130, 132 of the drivetrain busbar 16 and the RESS 102. For example, the second contactor 116 is controlled to a closed position to establish the electrical connection during a discharging mode of the battery pack 10 (e.g., when the battery pack 10 is powering one or more of the loads 134, 136, 138, 140, 142, 144, 146, 148). The second contactor 116 is controlled to an open position to break the electrical connection during a charging mode (e.g., fast charging mode) of the battery pack 10.

Although not shown in FIG. 7, it should be understood that the busbars 14, 16 may extend into and about the RESS 102. Further, the TIM 18 (not shown) described above with respect to FIGS. 1-6 is disposed between the two busbars, such as the fast charging or stack busbar 14 and the drivetrain busbar 16, that are not simultaneously active (e.g., receiving current). In this way, heat is transferred from the active, heat-generating busbar to the inactive busbar. As previously described, a location of the TIM 18 (not shown) may be at or adjacent to a hot spot in the battery pack 10, such as at or adjacent the shunt 106, although other locations are also possible in accordance with the present disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

1. A battery pack, comprising:
a first busbar;
a second busbar;
a thermal interface material (TIM) comprising a thermal conductivity constant (k) value between 1.0 and 7.0 watts per meter-kelvin (W/mK), wherein the TIM establishes a thermal interface between the first busbar and the second busbar; and
a control assembly configured to regulate a charging mode of the battery pack in which the first busbar is active and receives an electrical current and the second busbar is inactive.

2. The battery pack of claim 1, comprising a fast charging or stack busbar corresponding to the first busbar.

3. The battery pack of claim 2, comprising a drivetrain busbar corresponding to the second busbar.

4. The battery pack of claim 1, comprising a pressure sensitive adhesive (PSA) coupling the TIM to the first busbar, the second busbar, or both.

5. The battery pack of claim 1, wherein the TIM establishes the thermal interface between the first busbar and the second busbar along a majority of a longitudinal portion of a bussing assembly comprising the first busbar and the second busbar, in which the first busbar and the second busbar extend in a common direction.

6. The battery pack of claim 1, wherein the TIM is disposed at or adjacent to a hot spot corresponding to a shunt of the battery pack.

7. The battery pack of claim 6, wherein the shunt is disposed in or adjacent to a rechargeable energy storage system (RESS).

8. The battery pack of claim 1, comprising:
an enclosure including a base and a lid;
a plurality of battery cells disposed in the base and enclosed in the enclosure via the lid; and
a gap between the first busbar and the lid, wherein a first portion of the TIM establishes the thermal interface between the first busbar and the second busbar, and a second portion of the TIM establishes an additional thermal interface between the lid and either the first busbar or the second busbar.

9. The battery pack of claim 1, wherein the TIM comprises a liquid cured into a solid between the first busbar and the second busbar.

10. The battery pack of claim 1, wherein the k value of the TIM is between 2.5 and 6.0 W/mK.

11. The battery pack of claim 1, wherein the battery pack comprises:
a low voltage (LV) portion and the first busbar corresponds to the LV portion; and
a high voltage (HV) portion and the second busbar corresponds to the HV portion.

12. A battery pack, comprising:
an enclosure;
a plurality of battery cells disposed in the enclosure;
a fast charging or stack busbar disposed in the enclosure, electrically coupled with the plurality of battery cells, and configured to establish a first electrical connection between a charger and the plurality of battery cells;
a drivetrain busbar disposed in the enclosure, electrically coupled with the plurality of battery cells, and configured to establish a second electrical connection between the plurality of battery cells and one or more loads; and
a thermal interface material (TIM) establishing a thermal interface between the fast charging or stack busbar and the drivetrain busbar.

13. The battery pack of claim 12, comprising a control assembly configured to regulate a charging mode of the battery pack in which the fast charging or stack busbar is active and receives an electrical current and the drivetrain busbar is inactive.

14. The battery pack of claim 12, comprising a control assembly configured to regulate a discharging mode of the battery pack in which the drivetrain busbar is active and receives an electrical current and the fast charging or stack busbar is inactive.

15. The battery pack of claim 12, comprising a pressure sensitive adhesive (PSA) coupling the TIM to the fast charging or stack busbar, the drivetrain busbar, or both.

16. The battery pack of claim 12, comprising:
a base of the enclosure, wherein the plurality of battery cells, the fast charging or stack busbar, the drivetrain busbar, and the TIM are disposed in the base;
a lid coupled to the base; and
a gap extending from the lid to the drivetrain busbar, wherein a first portion of the TIM establishes the thermal interface between the fast charging or stack busbar and the drivetrain busbar, and a second portion of the TIM establishes an additional thermal interface between the drivetrain busbar and the lid.

17. A bussing assembly configured to be disposed in an enclosure of a battery pack, comprising:
a first busbar configured to be active in a charging mode of the battery pack;
a second busbar configured to be inactive in the charging mode of the battery pack; and
a thermal interface material (TIM) comprising a thermal conductivity constant (k) value between 1.0 and 7.0 watts per meter-kelvin (W/mK), wherein the TIM establishes a thermal interface between the first busbar and the second busbar.

18. The bussing assembly of claim 17, wherein the first busbar corresponds to a fast charging or stack busbar, and the second busbar corresponds to a drivetrain busbar.

19. The bussing assembly of claim 17, comprising a pressure sensitive adhesive (PSA) coupling the TIM to the first busbar, the second busbar, or both.

20. The bussing assembly of claim 17, wherein the first busbar is electrically isolated from the second busbar at least during the charging mode of the battery pack.
